(19) United States
(12) Patent Application Publication
(10) Pub. No.: US 2013/0041675 A1
(43) Pub. Date: Feb. 14, 2013

(54) Method for Administering A Pharmaceutical Product Donation Program

(71) Applicants: David W. Cunningham, Raleigh, NC (US); Edward Petrella, Raleigh, NC (US)

(72) Inventors: David W. Cunningham, Raleigh, NC (US); Edward Petrella, Raleigh, NC (US)

(21) Appl. No.: 13/205,349

(22) Filed: Aug. 8, 2011

(51) Int. Cl. G06Q 50/00

(52) U.S. Cl. 705/2

(57) ABSTRACT

A method of distributing and tracking donated prescription medicines includes a pharmaceutical donor donating in-kind pharmaceutical products to a non-profit organization which then transfers the donated pharmaceutical products to a pharmaceutical distributor. An electronic record is established indicating a credit with pharmaceutical distributor in favor of the non-profit organization. After a pharmacy has distributed a pharmaceutical to an eligible patient, the pharmacy notifies the non-profit organization of the transaction and the non-profit organization authorizes the pharmaceutical distributor to apply to the credit to the benefit of the pharmacy.

### FIELD OF THE INVENTION

The present invention relates to a system and method for administering a pharmaceutical product donation program where prescription medicines are donated by pharmaceutical entities to patients through a retail pharmacy network.

### BACKGROUND OF THE INVENTION

Pharmaceutical entities offer medication assistance programs through in-kind donations of medicines to eligible individuals and families. These programs have various criteria that determine recipient eligibility. Typically, these programs require a doctor's attestation and patient eligibility as demonstrated by proof of need defined in the IRS Code and U.S. Department of Revenue regulations.

In current in-kind donation programs of medication, it is challenging for pharmaceutical entities to track and account for the donated medicines that are delivered to eligible patients. In some cases, pharmaceutical entities donate in-kind medicines to physicians or directly to eligible patients. In other cases, pharmaceutical entities deliver donated medicines to an authorized dispensing agent who then ships the donated medicines to physicians' offices or directly to eligible patients. The present invention presents an improved process for delivering and tracking donated medicines to eligible patients.

### SUMMARY OF THE INVENTION

The present invention is directed toward a method of distributing donated prescription medicines to eligible patients through a charitable program. A non-profit entity receives in-kind pharmaceutical product donations from a donor, such as a pharmaceutical manufacturer, and transfers the donated pharmaceutical products to a pharmaceutical distributor, such as a wholesale distributor. Once the donated pharmaceutical products are transferred to the pharmaceutical distributor, the pharmaceutical distributor establishes a credit account and applies a credit amount to the credit account for the benefit of the non-profit entity. An electronic record is established that indicates the credit. The pharmaceutical distributor then receives title to and integrates the donated pharmaceutical products into its trade inventory for sale in the normal stream of commerce to pharmacies in a retail network. When a patient presents an approved access card with an authorized prescription to the pharmacy that indicates that the patient is eligible for participation in the program, the pharmacy dispenses an appropriate pharmaceutical product from its inventory to the patient at no cost and electronically notifies the non-profit entity of the event. The non-profit entity then electronically authorizes the pharmaceutical distributor to transfer an appropriate credit amount to the pharmacy. Transferring the credit to the pharmacy allows the pharmacy to replace the dispensed pharmaceutical product that was delivered to the eligible patient at no cost.

The present invention is also directed to a processor configured to track the delivery of donated pharmaceutical products. In particular, the processor is configured to update an electronic record indicating receipt of in-kind pharmaceutical product donations from a donor and update the electronic record indicating that the received donated pharmaceutical products have been transferred to a pharmaceutical distributor. The processor is also configured to establish an electronic record indicating a credit amount with the pharmaceutical distributor and is also configured to electronically authorize the pharmaceutical distributor to transfer the credit to a pharmacy associated with the pharmaceutical distributor that has delivered a pharmaceutical product to a patient at no cost.

Other objects and advantages of the present invention will become apparent and obvious from a study of the following description and the accompanying drawings which are merely illustrative of such invention.

### BRIEF DESCRIPTION OF THE DRAWINGS

FIG. 1 is a schematic illustration of the method for delivering in-kind pharmaceutical product donations.

FIG. 2 is a schematic illustration of an exemplary network used to manage the medication assistance program.

FIG. 3 is a schematic illustration of an exemplary computing system.

FIG. 4 is a flow chart illustrating the logic utilized to track donated medicines and account for the distribution and disbursement of the donated medicines.

### DETAILED DESCRIPTION

The present invention is directed toward a system and method for delivering and tracking in-kind pharmaceutical product donations to eligible patients through a medication assistance program. In a typical embodiment of the present invention, pharmaceutical product donors, such as pharmaceutical manufacturers donate in-kind pharmaceutical products to a non-profit entity that receives and takes title to the donated pharmaceutical products. In one embodiment, the non-profit entity is a §501(c)(3) charitable organization as defined by the U.S. tax code. Once the donated pharmaceutical products are received by the non-profit entity, the non-profit entity transfers the donated pharmaceutical products to one or more pharmaceutical distributors, such as national and regional wholesale pharmaceutical suppliers.

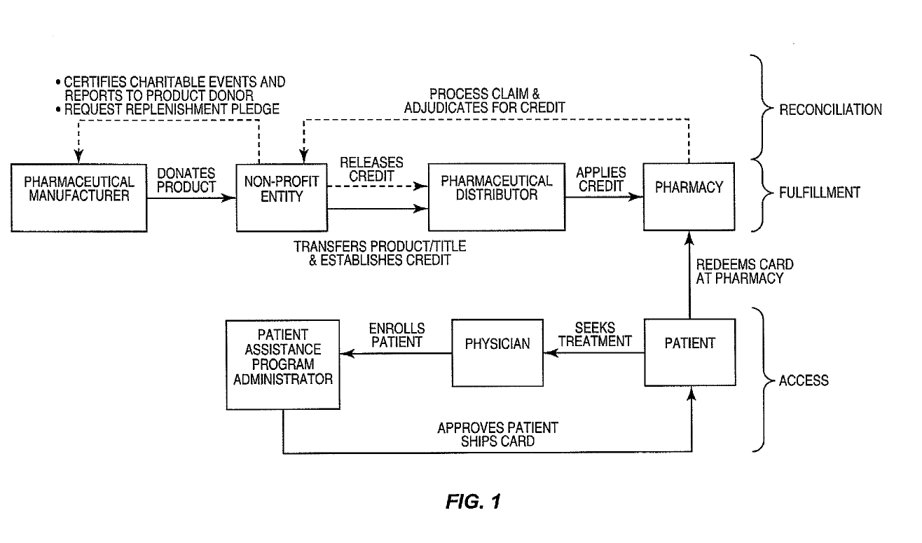

FIG. 1 depicts a schematic illustration of an exemplary relationship between a pharmaceutical donor, a non-profit entity, a pharmaceutical distributor, a pharmacy, a program administrator, a physician, and a patient. In this embodiment, the pharmaceutical donor is a pharmaceutical manufacturer and the pharmaceutical distributor is a wholesale distributor. As shown in the figure, the pharmaceutical manufacturer donates prescription medicines to the non-profit entity, which in turn, transfers the donated medicines to a wholesale distributor in exchange for the establishment of credit account based on the value of the medicine at the time of donation. Various means may be employed to determine value and resulting credit. In one embodiment, the credit is the donor's published wholesale acquisition cost of the donated products.

The pharmaceutical distributor inventories the donated pharmaceutical products along with its trade supply of pharmaceutical products. The pharmaceutical distributor then sells the donated pharmaceutical products, along with its inventory of non-donated pharmaceutical products, in its normal stream of commerce to various retail pharmacies. Thus, the donated medicine distributed to the pharmaceutical distributors and ultimately participating pharmacies does not have to be separated or sequestered from regular inventory. Patients that are eligible to participate in the medication assistance program, receive free pharmaceutical products at the pharmacies.

To qualify for eligibility into the medication assistance program, a patient first seeks treatment with a physician. Physicians often encounter patients that are in need of prescription medicines, and may be eligible for free medicines through the program. A physician conducts a preliminary screening of the patient and then contacts a program administrator when it appears that a patient may qualify for eligibility. In some cases the physicians will prepare applications for patients and submit appropriate documentation that establishes that the patient meets the requirements for the program. The program administrator will follow up with the patient directly and obtain additional information relating to qualification. Thus, the program administrator evaluates the applications and determines eligibility. In one embodiment, the non-profit entity and the program administrator are the same entity. In these cases, the non-profit entity evaluates the applications and determines eligibility of patients.

The program administrator administers the application process for patients based on preset criteria. Once it is determined that a patient qualifies for participation in the program, a card, voucher or other media is delivered to the patient for use in obtaining one or more prescription medicines that are provided under the program. However, in another embodiment, the physician supplies the eligibility card to the patient at the time of initial enrollment and the program administrator simply activates the card upon determination that the patient qualifies for eligibility in the program.

Thereafter, the patients present the card, voucher or media along with a prescription from the physician to the pharmacy. An activated card, voucher, or other media can be used by an eligible patient to obtain any prescribed drug by the physician that has been donated through an in-kind donation to the non-profit entity. After verifying the authenticity of the card with the program administrator, the pharmacy provides the patient with the pharmaceutical product identified on the card and the prescription at no cost. Typically, the card, voucher or other media will identify the patient, the medicine or medicines covered under the medication assistance program, the term of use, and other data and information that might be helpful in tracking the medicine and validating requests for medicines for eligible patients. The card allows the redemption to be recognized by the pharmacy's processing system as a program claim and be adjudicated through accounting procedures that enable the pharmacy to be compensated for the service and for the pharmaceutical donor to be credited with a charitable event certification for enhanced donation credit or value.

In order to be reimbursed for delivery of free pharmaceutical products, pharmacy then notifies the non-profit entity that the pharmacy dispensed free medicine to an eligible patient participating in the program. The pharmacy electronically provides identifying information on the card to the non-profit entity to evidence that the card is valid and active. In response, the non-profit entity authenticates the validity of the card and authorizes the pharmaceutical distributor to release credit from the credit account it holds in favor of the non-profit entity and apply the credit to the pharmacy to reimburse the pharmacy for the product delivered to the eligible patient. In another embodiment however, the pharmacy notifies the program administrator that the pharmacy delivered a free medicine to an eligible patient and electronically provides the program administrator identifying information on the card to evidence that the card is valid and active. The program administrator then notifies the non-profit entity of the delivery of the donated medicines, and in turn, the non-profit entity then authorizes the wholesale distributor to apply the credit to the pharmacy. In one embodiment, the credit is a deduction of the payment owed by the pharmacy to the pharmaceutical distributor. After the medicine has been delivered to an eligible patient participating in the medication assistance program, the non-profit entity notifies the donor that a charitable donation of in-kind pharmaceutical product has been made on the donor's behalf.

During the above described process, accounting functions are performed that track the donated medicines, account for the donated medicine as it moves from the pharmaceutical manufacturer to the control of the non-profit entity and to the control of the wholesale distributors. The accounting functions also track the donated medicines that are delivered to eligible patients through pharmacies. In addition, the accounting process calculates a donation credit or value in favor of the pharmaceutical manufacturer or donor as units or quantities of the donated medicines are dispensed by the participating pharmacies.

Moreover, it is noted that the eligibility card described herein typically includes three unique identifiers: a member number, a group number and a bank identification number (BIN). The member number identifies the patient's eligibility and formulary of approved products. The group number identifies which pharmacy benefit manager's rules that the non-profit entity will employ. Finally, the BIN is used to electronically route the prescription claim via a switch to the prescription processor. Using the patient's eligibility card, the pharmacist transmits the claim to the non-profit entity or the administrator which validates and authenticates the pharmacy identification, patient eligibility, prescribing physician name, drug enforcement agency number, product name, national drug code, strength, form, quantity and day's supply. If the information is correct, a message is returned instructing the pharmacist to dispense the product. If any piece of the information is incorrect, the claim is rejected.

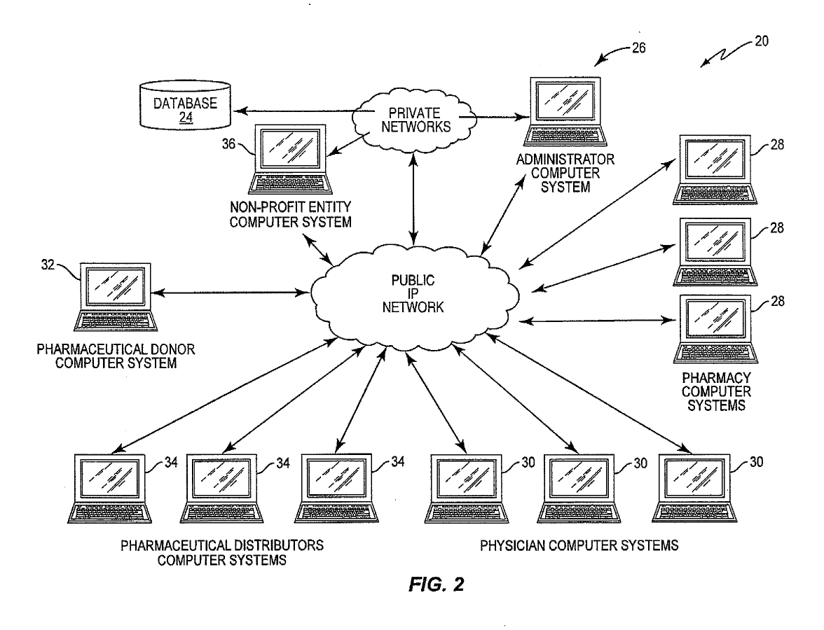

Turning to FIG. 2, a schematic illustration is shown for a communication network that links the pharmaceutical donor, the non-profit entity, the pharmaceutical distributor, the program administrator, participating pharmacies, and physicians. The network is indicated by the numeral 20 and can be a public or private network. In the embodiment illustrated, the total network comprises both a public and a private network. As previously stated, the non-profit entity and administrator may be separate entities. In this case, an administrator computer system 26 is managed by a program administrator, while the non-profit computer system 36 is managed by a separate non-profit entity. In other embodiments, the non-profit entity may also function as the program administrator. In this case, administrator computer system 26 is managed by the non-profit entity. Both the administrator computer system 26 and the non-profit entity computer system 36 typically include conventional types of computing devices such as processors, software, storage, network interface units, input/output devices etc. and communicate with the database 24 via a private network. Further, those skilled in the art will readily appreciate that the administrator computer system 26 and the non-profit computer system 36 may be any computer system known in the art. Some exemplary systems include, but are not limited to, personal desktop computers, laptop computers, work stations, notebook computers, servers and super computing devices. Each computer system may also be a part of a distributed system with the capability to perform the tracking, accounting and other functions appropriate for administering the medication assistance program.

Communicatively connected to the administrator computing system 26 and the non-profit entity computer system 36 via a public IP network is a plurality of pharmacy computer systems 28, physician computer systems 30, and pharmaceutical distributors' computer systems 34. Pharmacy computer systems 28 are typically located in the participating pharmacies and enable the pharmacies to communicate directly with the non-profit entity and/or the administrator computer system 26. Likewise, physician computer systems 30 are typically located in the physicians' offices and enable the physicians to communicate directly with the non-profit entity and/or the administrator computer system 26.

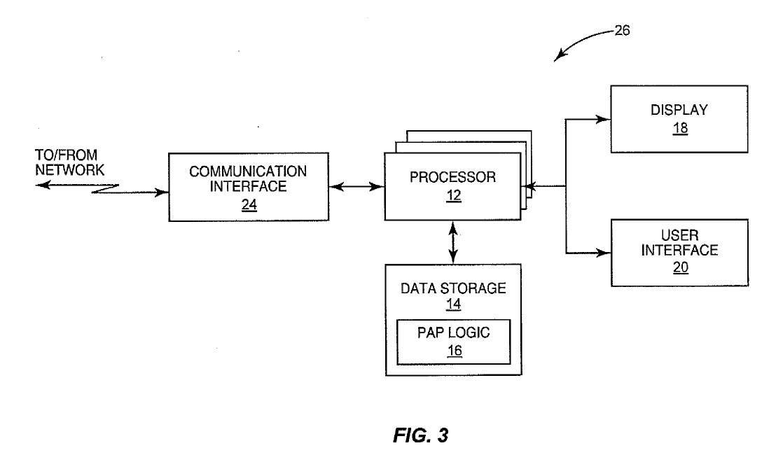

FIG. 3 illustrates a functional block diagram of a representative processor 12 that can be used to track and perform accounting functions for certification of the medication program. The processor 12 can stand alone or be located in either the administrator computer system 26, as indicated in FIG. 3, or in the non-profit entity computer system 36. As shown in FIG. 3, the administrator computer system 26 includes one or more processors 12 capable of executing software programs stored in data storage 14. Data storage 14 represents the entire hierarchy of memory in administrator computer system 26, and may include random access memory (RAM), read-only memory (ROM), non-volatile memory, optical storage devices, hard disk drives, etc. Software programs and data required for operating administrator computer system 26 may be loaded into volatile memory regions of the data storage 14 and/or permanently stored in non-volatile memory regions, and may be implemented as any type of computer readable code capable of execution by the processor 12.

Software programs may include an operating system such as WINDOWS XP or NT, UNIX, LINUX, APPLE COMPUTER's S OS X, and the like. Software programs may also include user application programs that perform functions for the user. In one embodiment, for example, data storage 14 stores an application software program that defines the instructions for the tracking and accounting logic 16. As will be appreciated by those skilled in the art, the logic 16 performs numerous functions including determining whether a particular patient is qualified to participate in the medication assistance program as well as tracking and accounting functions. For example, at any time, for a certain donated medicine, the logic determines the number of units donated to the non-profit entity, when the non-profit entity took possession or control of the donated medicine, the number of units distributed to pharmaceutical distributors, the identity of the pharmaceutical distributors receiving donated medicine, and the earned donation credits or donation value attributable to the donated medicine dispensed by the pharmacies. These are exemplary functions of the logic 16 and it is appreciated that the functions of the logic 16 can be extensive in order that the entire medication assistance program can be administered by the administrator computer system 26.

Processor 12 may also communicatively connect to a display 18 and a user interface 20. Display 18 may comprise a traditional CRT monitor, a liquid crystal display (LCD), a plasma screen, or the like. Processor 12 may output the results obtained from executing logic 16 to the display 18 for viewing by the user. User interface 20 may include, inter alia, a keyboard and/or a pointing device such as a mouse, voice response system, touch screen, etc. User interface 20 permits a user to enter commands, data, and generally control the operation of computer system 26.

A removable computer-readable media portion of the data storage 14 may contain a variety of digital data, and in particular may contain program logic 16. Logic 16 may be copied from the removable media to a fixed disk drive, and subsequently loaded into one or more memory components of the data storage 14. Alternatively, the logic 16 may be loaded directly from the removable media into the one or more memory components.

Optionally, administrator computer system 26 and/or the non-profit entity computer system 36 may include a communications interface 24 to communicate with one or more remote computing devices via a communications network. Communications interface 24 may comprise any interface known in the art. One such example of a suitable interface includes an Ethernet-based interface adapter cards such as 10-BASE-T, Fast Ethernet, 10 GbE, or the like. Alternatively, communications interface 24 may be a wireless interface card operating according to WiFi standards (e.g., IEEE 802.11) or BLUETOOTH. Those skilled in the art will appreciate that the interfaces listed herein does not comprise an exhaustive list, and that there are many additional interfaces that may be used to connect computer system 26 to a communications network.

The system, process and software disclosed herein are designed to track the donated medicines through the retail pharmaceutical distribution channels. In addition to tracking the donated medicines, the system, process and software performs various accounting functions that calculate and verify a donation credit or value that is due the pharmaceutical donor. To achieve this, the tracking and accounting program provides a separate account for each pharmaceutical donor and for each prescription medicine donated by the pharmaceutical donor. This enables the movement of donated medicines to be accurately tracked and accounted for and permits the non-profit entity to verify charitable events.

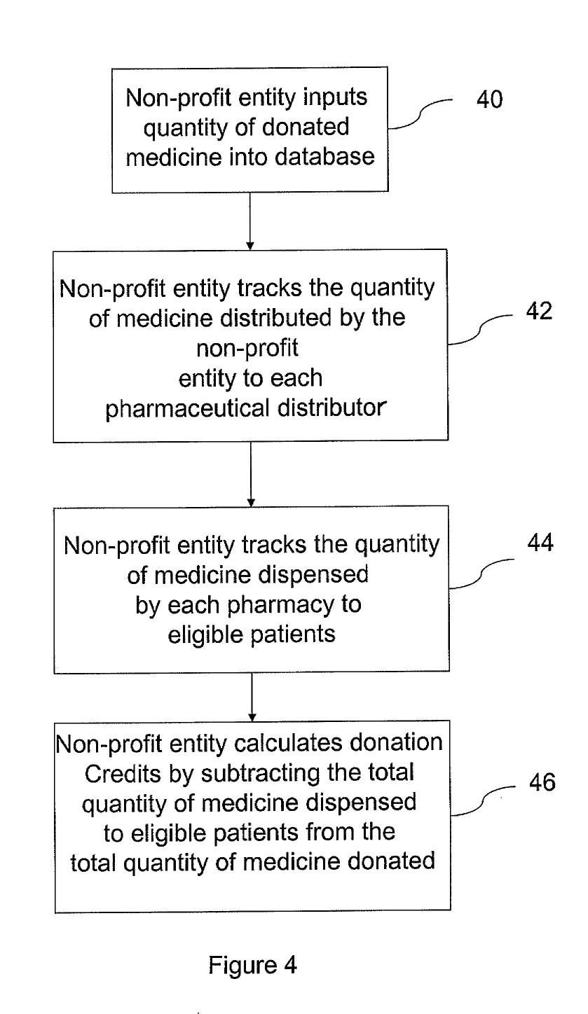

FIG. 4 illustrates program logic that can be used for tracking donated medicines associated with a medication assistance program. Once the pharmaceutical donor has donated a quantity of medicine for distribution as a part of the medication assistance program to the non-profit entity, the quantity of donated medicine is inputted into the database 24 and organized or maintained in a separate account for the pharmaceutical donor and for that particular donated medicine. (Block 40). As discussed herein, once the pharmaceutical donor has donated a particular medicine, the non-profit entity takes possession or control of the donated medicine. Thereafter, the non-profit entity transfers the donated medicine to one or more pharmaceutical distributors. Donated product is fungible, which means that it can be integrated with the distributor's trade product and logically partitioned rather than physically sequestered for the benefit of the non-profit. The pharmaceutical distributors then, through their normal stream of commerce, distribute the donated medicine, along with non-donated medicine, to one or more pharmacies. The non-profit entity uses the computing system 36 to track the quantity of donated medicine distributed to the pharmaceutical distributors (Block 42). Program logic tracks this donation information in the database 24. In one embodiment, the computer system 36 updates corresponding records stored in the database 24 to reflect the distribution of donated medicine to a pharmaceutical distributor.

The participating pharmacies dispense medicine to eligible patients who have in their possession a card, voucher or other media that evidences enrollment in the medication assistance program. Each pharmacy when presented with such a card, voucher or media will execute a validation process that may entail validating that the pharmacy itself is a qualified participant in the medication assistance program and validating the authenticity of the card, voucher or media presented by the patient. The computing system and the logic will verify and validate the identity of the pharmacy and patient and based on records in the database and will determine if the patient is permitted to receive donated medicine at no cost.

Once various validations have been executed and the computing system determines that it is appropriate to dispense donated medicine to the patient, the pharmacy will be so authorized. The pharmacy will communicate to the non-profit entity via computer system 36 the identity and quantity of medicine that has been dispensed to the patient. In response, the non-profit entity computer system 36 tracks the medicine dispensing event, i.e., by updating the appropriate records in the database 24. (Block 44). In another embodiment, the pharmacy communicates to the program administrator via computer system 26 the identity and quantity of medicine that has dispensed to the patient. The program administrator computer system 26 then notifies the non-profit entity computer system 36 that the medicine has been dispensed. In response, the non-profit entity computer system 36 updates the database 24 to reflect the dispensation of the medicine.

Periodically, the logic will calculate donation credits. A properly dispensed donated medicine from a pharmacy will constitute a donation credit or a donation value that will ultimately be certified by the non-profit entity and which will be reported to pharmaceutical donor. In one embodiment, the donation credits are calculated on an ongoing basis by the computing system by subtracting the total quantity of donated medicine dispensed from the total quantity of medicine donated. (Block 46). Alternatively, the logic calculates donation credits on an occurrence basis based on a value per unit of medicine dispensed. That is, once a participating pharmacy has dispensed a donated medicine to an eligible patient, and the non-profit organization has been notified of the dispensation, the logic automatically calculates a donation credit or a donation value which is reported to pharmaceutical donor

The non-profit entity submits reports to the pharmaceutical donor. The reports may include a certification of charitable events. That is, the nonprofit organization will certify that it received possession or control of a certain number of units of a selected medicine and that a certain quantity of the donated medicine was distributed to eligible patients pursuant to the medication assistance program.

In one example, the non-profit entity receives $1000 worth of donated medicine ABC from a pharmaceutical donor. The non-profit entity distributes the $1000 worth of medicine ABC to a pharmaceutical distributor, which in turns provides the non-profit entity with a credit valuing $1000. The pharmaceutical distributor takes control of the donated medicines and places them in their inventory of non-donated retail medicines. A pharmacy purchases $200 worth of medicine ABC from the pharmaceutical distributor. An eligible patient presents the pharmacy with a valid and active card which indicates that the patient is entitled to $50 worth of free medicine ABC. The pharmacy notifies the non-profit entity that it has distributed $50 worth of free medicine ABC to an eligible patient through the medication assistance program. In response, the non-profit entity authorizes the pharmaceutical distributor to release $50 of the credit to the pharmacy, The pharmaceutical distributor then applies a $50 credit to an invoice to the pharmacy from the credit account established by the product transferred from the non-profit. In addition, the non-profit entity notifies the pharmaceutical donor that the pharmaceutical donor has made a charitable donation of in-kind pharmaceutical product worth $50.

The claims adjudication process as just described benefits both pharmaceutical donors and patients by making more donated product available in a wider reaching and secure retail dispensing network of pharmacists. Thus, this distribution process makes donated product available to patients on a broader scale. In addition, patients will have the benefit of face-to-face interaction with a local pharmacist.

Further, the software program or program logic disclosed herein may perform other functions than those described. For example, it is contemplated that the non-profit entity will be compensated to cover costs associated with distributing the donated medicine. In addition, the participating pharmacies will also be compensated for bona fide service fees associated with the dispensing of the donated medicines to the eligible participants in the medication assistance program. The computing software can automatically compute various service fees due the non-profit entity and participating pharmacies based on a variety of criteria. For example, the service fee may simply be based on the number of units distributed by the non-profit entity and for the pharmacies may be based on the number of units dispensed by the pharmacies. The accounting scheme and program disclosed herein can calculate those fees on an ongoing basis.

In describing how patients come to access donated prescription pharmaceutical products, the specification and claims may state that a pharmacy has delivered a donated prescription product to a patient. In this context, the term “donated prescription pharmaceutical product” or “donated pharmaceutical product” means an actual pharmaceutical product that was donated by the donor or means a pharmaceutical product that is the same or equivalent to the actual donated pharmaceutical product. In addition, the specification and claim sometimes refers to a pharmacy or pharmacies being associated with the pharmaceutical distributor. “Associated” in this context simply means that there is a business relationship between the pharmacy or pharmacies and the pharmaceutical distributor or that the pharmacy or pharmacies have purchased or received pharmaceutical products from the pharmaceutical distributor.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

What is claimed is:

1. A method of distributing prescription medicines to eligible patients at no cost comprising:
a. receiving an in-kind pharmaceutical product donation from a donor;
b. transferring the donated pharmaceutical product to a pharmaceutical distributor;
c. establishing an electronic record indicating a credit with the pharmaceutical distributor in response to transferring the donated pharmaceutical product to the pharmaceutical distributor;
d. receiving and authenticating electronic notification that a pharmacy associated with the pharmaceutical distributor delivered a pharmaceutical product to a patient at no cost, wherein the pharmaceutical product is of the same type as the donated pharmaceutical product;
e. electronically authorizing the pharmaceutical distributor to transfer the credit to the pharmacy so that the pharmacy can be reimbursed for the delivery of the pharmaceutical product to the patient.

2. The method of claim 1 wherein establishing an electronic record indicating a credit further comprises determining the value of the credit based on the value of the pharmaceutical product donation.

3. The method of claim 1 wherein establishing an electronic record indicating a credit further comprises determining the value of the credit based on the wholesale value of the pharmaceutical product donation.

4. The method of claim 1 further comprising notifying the donor that a charitable donation of in-kind pharmaceutical product has been made on the donor's behalf.

5. The method of claim 1 further comprising determining eligibility requirements for patients to receive pharmaceutical products at no cost.

6. The method of claim 1 further comprising providing eligibility requirements for patients to a program administrator so that the program administrator can approve patients for receiving pharmaceutical products at no cost from the pharmacy.

7. The method of claim 1 wherein receiving electronic notification that the pharmacy delivered the pharmaceutical product to a patient at no cost comprises receiving the electronic notification from the pharmacy.

8. The method of claim 1 wherein receiving electronic notification that the pharmacy delivered the pharmaceutical product to a patient at no cost comprises receiving the electronic notification from a program administrator.

9. A processor configured to:
a. update an electronic record indicating receipt of an in-kind pharmaceutical product donation from a donor;
b. update the electronic record indicating that the received donated pharmaceutical product has been transferred to a pharmaceutical distributor;
c. establish an electronic record indicating a credit with the pharmaceutical distributor;
d. receive electronic notification that a pharmacy associated with the pharmaceutical distributor delivered a pharmaceutical product to a patient at no cost, wherein the pharmaceutical product is of the same type as the donated pharmaceutical product;
e. electronically authorize the pharmaceutical distributor to transfer the credit to the pharmacy so that the pharmacy can be reimbursed for the delivery of the pharmaceutical product to the patient.

10. The processor of claim 9 further configured to determine the value of the credit based on the value of the pharmaceutical product donation.

11. The processor of claim 9 further configured to determine the value of the credit based on the wholesale value of the pharmaceutical product donation.

12. The processor of claim 9 further configured to electronically notify the donor that a charitable donation of in-kind pharmaceutical product has been made on the donor's behalf.

13. The processor of claim 9 further configured to determine eligibility for patients to receive pharmaceutical products at no cost.

14. A method of donating prescription pharmaceutical products and distributing the donated prescription pharmaceutical products to eligible patients, comprising:
a. receiving in-kind donations of prescription pharmaceutical products from a donor;
b. transferring the in-kind donated prescription pharmaceutical products to a pharmaceutical distributor who in turn sells the donated prescription pharmaceutical products to one or more pharmacies;
c. establishing an electronic record indicating a credit with the pharmaceutical distributor as a result of the donated pharmaceutical prescription products being transferred to the pharmaceutical distributor;
d. receiving an electronic notification that one of the pharmacies has delivered a donated pharmaceutical product to a patient at no cost; and
e. electronically authorizing the pharmaceutical distributor to transfer an appropriate credit to the pharmacy that delivered the donated prescription product to the patient.

15. The method of claim 14 wherein the credit established is a function of a value of the donated pharmaceutical products.

16. The method of claim 14 further comprising notifying the donor that a charitable donation of an in-kind pharmaceutical product has been made on the donor's behalf.

17. The method of claim 14 further including electronically determining the dollar amount of charitable donations made as a result of the donated pharmaceutical products being delivered to patients.

18. The method of claim 17 further comprising notifying the donor of the amount of charitable donations that resulted from the delivery of a certain amount of donated pharmaceutical products.
